(19) United States
(12) Patent Application Publication
(10) Pub. No.: US 2007/0189470 A1
(43) Pub. Date: Aug. 16, 2007

(54) System and method for providing real time news

(76) Inventor: Duk-Young Yoon, Seoul (KR)

Correspondence Address: Robert E. Bushnell;Suite 300, 1522 K Street, N.W., Washington, DC, 20005-1202, US

(21) Appl. No.: 11/636,669

(22) Filed: Dec. 11, 2006

(30) Foreign Application Priority Data
Jan. 27, 2006 (KR) 10-2006-0009116

(51) Int. Cl. H04M 11/00

(52) U.S. Cl. 379/88.13

(57) ABSTRACT

In a system and method for providing real time news, web blog information, and the like to a mobile terminal in a communication network, an RDF Site Summary (RSS) document is used to provide the news information, thereby standardizing an object for news information extraction and reducing the time consumed in providing news information.

### CLAIM OF PRIORITY

This application makes reference to, incorporates the same herein, and claims all benefits accruing under 35 U.S.C.§119 from an application for SYSTEM AND METHOD FOR PROVIDING REAL TIME NEWS earlier filed in the Korean Intellectual Property Office on the of Jan. 27, 2006 and there duly assigned Serial No. 10-2006-0009116.

### BACKGROUND OF THE INVENTION

1. Technical Field

The present invention relates to a system and method for providing real time news, web blog information, and the like, to a mobile terminal in a communication network.

2. Related Art

Currently, information carries great significance to the extent that the modern society in which we live has been dubbed as the information society, and information is getting more important. Responding to such a trend, various methods for providing information are being suggested, and one of the most frequently used means for providing information is the mobile terminal.

Meanwhile, in order to meet one of the most critical points in providing information, i.e., prompt information delivery, information is currently provided in real time.

Generally, in a method for providing real time information using a mobile terminal, collected information is outputted through a display unit of the mobile terminal so that the user can confirm the information.

The mobile terminal, however, requires a different information providing method than a computer does due to constraints such as processing speed, display size, etc. In a conventional method for providing information to a mobile terminal (hereinafter, referred to as a “terminal”), contents of a webpage composed using Hyper Text Markup Language (HTML) are loaded and parsed to extract a title of news and to output it as news information.

However, the existing method for extracting news information from a webpage composed using HTML has the following problems.

When an HTML page is loaded and the contents thereof are parsed, the structure and composition form of the page should be parsed whenever the page is updated. Otherwise, it may fail to identify the news title dependent on the structure of the page upon update of the pages.

Furthermore, since different document expression rules and content formats may be used from website to website, an analysis method may depend on the content formats. For example, content analysis requires extracting a news list from a table in a particular website, and from a portion of contents spoken by a news anchor in other websites. In this case, it is difficult to extract the contents of the news by using a normal method.

In addition, HTML pages having a large amount of contents, i.e., lengthy data, take a long time to load the contents and to parse the loaded data. In addition, it is difficult to extract a title and content of an article since news is not provided in a standardized format.

To overcome the above problems, there is a need for a system and method for providing real time news, the system and method being capable of standardizing objects for news information extraction and enhancing information providing speed.

### SUMMARY OF THE INVENTION

It is an object of the present invention to provide a system and method for providing real time news, the system and method being capable of standardizing objects for news information extraction.

It is another object of the present invention to provide a system and method for providing the real time news, the system and method being capable of enhancing news providing speed.

According to a first aspect of the present invention, a system for providing real time news comprises: at least one news providing server for collecting and parsing RDF Site Summary (RSS) data, for extracting news information included in the RSS document, and for providing the extracted news information; and at least one mobile terminal for receiving the news information, and for displaying the received news information.

The system preferably further comprises a switch for receiving the news information provided by the news output server, and for transmitting the news information to the terminal.

The switch may transmit the received news information by converting the news information so that it is suitable for display on the terminal.

The news providing server preferably comprises an RSS collector for collecting the RSS document, and an RSS parser for extracting the news information to be provided from the collected RSS document.

The RSS parser calculates a size of the extracted news information, provides the news information to the extent of a predetermined reference value if it is determined that the size of the news information exceeds the reference value, and then deletes remaining news information.

The RSS parser determines if the news information, which corresponds in quantity to the reference value, has any incomplete letter information before deleting the news information. If it is determined that the news information, which corresponds in quantity to the reference value, includes incomplete letter information, the RSS parser adjusts the amount of the news information to be deleted so that the incomplete letter information becomes complete letter information.

The system preferably further comprises a storage unit for storing the extracted news information.

The RSS collector may collect the RSS document by using Hyper Text Transfer Protocol (HTTP). The RSS document may be in the form of an Extensible Markup Language (XML) document.

The news information comprises at least title and content information included in the XML document, and the RSS parser extracts the news information included in the XML document by parsing the XML document.

The terminal maybe at least one of a wired terminal, a wireless terminal and a wired and wireless terminal including a display.

The terminal may be an offiserv terminal including a Liquid Crystal Display (LCD) with two or more lines as a display.

The system preferably further comprises a keyphone news output server for receiving the extracted news information from the news providing server, for providing it to the terminal, for selecting news information from the received news information in response to a request for selective news information provision, and for providing the selected news information to the terminal.

According to a second aspect of the present invention, a method for providing real time news comprises the steps of extracting the news information included in the RS S document by collecting and parsing the RSS document, and providing at least one terminal with the extracted news information.

The method further comprises the step of converting the extracted news information so that it is suitable for displaying on the terminal.

The method also comprises the step of selecting the news information by means of the terminal.

The method further comprises the steps of calculating the size of the extracted news information, providing news information to the extent of a predetermined reference value when it is determined that the news information size exceeds the reference value; and deleting remaining news information.

The method also comprises the step of storing the extracted information.

As described above, according to the present invention, an RDF Site Summary (RSS) is used to provide real time news to the terminal.

The RSS is a format enabling a user to easily obtain updated information from websites having frequently updated contents, such as news, web blog, etc. The RSS document is based on an extensible Markup Language (XML), and is composed so as to be easily produced using minimum information required for distribution, such as title, contents, date, etc.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a diagram of a system for providing real time news according to an exemplary embodiment of the present invention;

FIG. 2 is a block diagram of a device for providing news according to an exemplary embodiment of the present invention; and

FIG. 3 is a flowchart of a process of providing news according to an exemplary embodiment of the present invention.

### DETAILED DESCRIPTION OF THE INVENTION

Hereinafter, exemplary embodiments of the present invention will be described in detail with reference to the accompanying drawings. In the following description, a detailed description of known functions and configurations incorporated herein has been omitted for conciseness.

The following Table 1 indicates an example of an RDF Site Summary (RSS) document.

TABLE 1

| RDF Site Summary (RSS) Item | Meaning and Usage of each item |
|---|---|
| | Declaration of Information required to |
| | parse XML |
| | Declaration of RSS Version |
| <title>Joongang Daily\|Whole articles | Meaning of beginning of RSS information |
| </title> | Recording a title of a site providing the |
| | RSS |
| <description>Joongang Daily leading | Recording URL of a site providing the RSS |
| innovation and changes in Korean press. | Recording brief description of the site |
| We will provide you with articles more | providing the RSS |
| precise than others for 24 hours through | |
| Internet, satellites, and a multimedia | |
| database. Your view will be upgraded by | |
| various articles provided by international | |
| press affiliated with Joongang Daily such as | |
| Newsweek, International Herald Tribune, | |
| etc. </description> | |
| | Declaration of language used in an RSS |
| <item> | document |
| <title> | Recording time when the RSS document is |
| <![CDATA[A regulation to lower the local | finally written |
| property tax in Gangnam was | Beginning of recording an article |
| passed...trouble with district council was | |
| made]] > | |
| </title> | Title of the article |
| | Web address in which a full sentence of the |
| | article is confirmed |
| <description> | Recording a part or a whole of the article |
| <![CDATA[After residents in Gangnam-gu | |
| hold a demonstration against lower property | |
| tax by a 50 percent in front of the district | |
| council on 4 Oct, they are watching the | |
| meeting. [by Sangsun Kim] hereinafter | |
| omitted. ]] > | |
| </description> | |
| | Recording time when the article is |
| | writtenDeclaration of finishing the |
| </item> | information on the article by closing a tag |
| | (repeating tag, <item>...</item> as the |
| | number of the article) |
| </channel> | Closing channel opened |
| </rss> | Closing the RSS tag opened. End of the |
| | RSS document |

The RSS document having the above configuration may be used in various fields, such as news and notice, lectures, schedule, search results, mailing lists, bidding information, recruiting information, etc.

The system to which the present invention is applied will now be described with reference to the accompanying drawings.

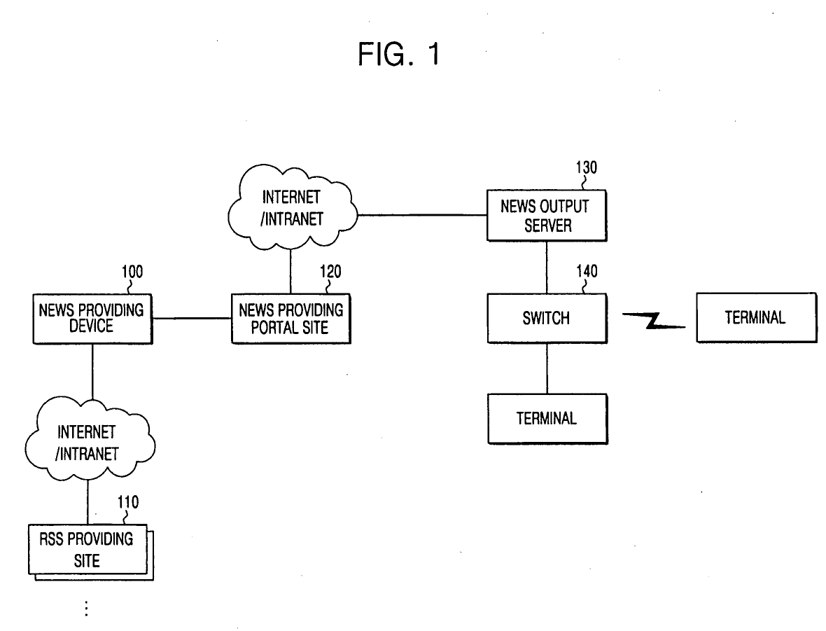

FIG. 1 is a diagram of a system for providing real time news according to an exemplary embodiment of the present invention.

Referring to FIG. 1, the system comprises a news providing device 100, an RSS providing site 110, a news providing portal site 120, a news output server 130, a switch 140 and at least one terminal 150, 152.

The news providing device 100 collects RSS documents from at least one RSS providing site 110. The news providing device 100 extracts news information included in the collected RSS document by parsing the collected RSS document. The news information extracted by the news providing device 100 is provided to the news output server 130 through the news providing portal site 120. The news providing device 100 and the news providing portal site 120 will be collectively referred to as a news providing server 160 unless otherwise mentioned.

The news output server 130 provides the news provided by the news providing server 160 to the switch 140. A Private Branch eXchange (PBX), a keyphone, or the like may be used as the switch 140. When the keyphone is used as the switch 140, the news output server 130 may be referred to as a keyphone news output server 130. The news output server 130 selects only news requested by the switch 140 and receives it from the news providing server 160.

The switch 140 may provide the news information, provided by the news output server 130, to at least one terminal 150, 152. The switch 140 may request the news output server 130 to selectively provide the news information. Generally, the news information is selected by a user, and the user's selection is transmitted to the switch 140 through the terminal 150, 152. In addition, the switch 140 performs a function of converting an output format of the news information provided by the news providing server 120 upon request. In this case, the output format of the news information may be determined by considering the user's request, as well as the type and form of the display unit of the terminal 150, 152.

The terminal 150, 152 displays the news information received from the switch 140. Various types of terminals, such as a wired terminal, a wireless terminal, and a wired and wireless terminal maybe used as the terminal 150, 152. However, the terminal 150, 152 should be equipped with a display unit which is capable of outputting the provided news information. An example of a terminal to which the present invention may be applied includes an officeServ terminal equipped with a Liquid Crystal Display (LCD) with two or more lines.

The RSS providing site 110, the news providing server 160, and the news output server 130 are connected by a network, such as the Internet or Intranet.

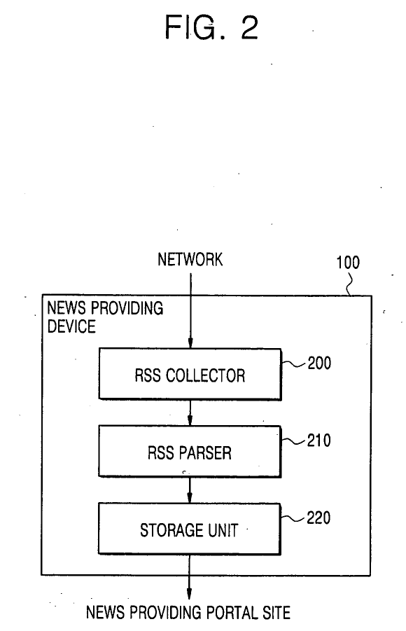

FIG. 2 is a block diagram of an example of a device for providing news according to an exemplary embodiment of the present invention.

The news providing device 100 includes an RSS collector 200, an RSS parser 210, and a storage unit 220.

The RSS collector 200 collects RSS documents from the RSS providing site 110. The RSS collector 200 may collect RSS documents by using the Hyper Text Transfer Protocol (HTTP). The RSS document is produced in XML. Extracting information from the document produced in XML may be performed easily and promptly by using tags.

The RSS parser 210 parses the RSS document which is an XML document. The RSS parser 210 has an HML parsing function to parse the RSS document. The RSS parser 210 has title and content information included in the RSS document by parsing the RSS document. News information to be provided to the terminal 150, 152 may include the title and content information. Of course, other information included in the RSS document, in addition to the title and content information, may be used if necessary.

The RSS parser 210 may limit the news information to be provided to the terminal 150, 152 to a predetermined size depending on settings related to constraints on the terminal 150, 152. The RSS parser 210 calculates a size of the extracted news information to determine whether the news information size exceeds a fixed reference value, deletes an excessive amount of the new information if the news information size exceeds the reference value, and provides the news information up to the reference value. At this point, the RSS parser 210 confirms the contents of the news information corresponding to the reference value, and determines if the news information includes incomplete letter information. An example of incomplete letter information is unfinished Korean alphabet characters. If the news information includes incomplete letter information, the RSS parser 210 adjusts the amount of the news information to be deleted so that the letter is completed.

The storage unit 220 stores the extracted news information. The news information may be stored in the form of a string.

A method for providing news information using the above-described real time news providing system will now be described with reference to the accompanying drawings.

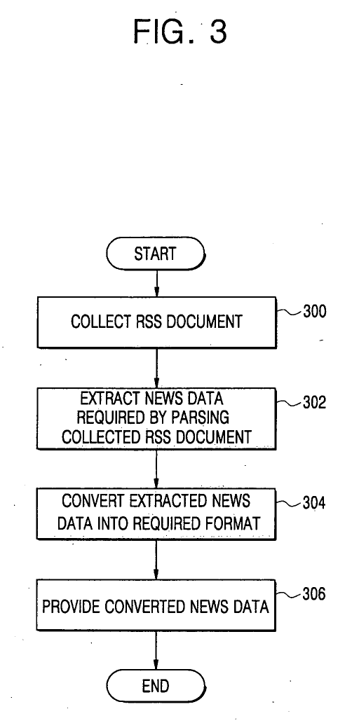

FIG. 3 is a flowchart of a process of providing news according to an exemplary embodiment of the present invention.

In step 300 of FIG. 3, RSS documents are collected. In step 302, the collected RSS documents are parsed, and desired news information is extracted. The extracted information is stored for future use. Steps 300 and 302 are performed by the news providing server. In step 304, the news information extracted in step 302 is converted into a format as requested. In step 306, the converted news information is provided to the terminal 150, 152. Steps 304 and 306 are performed by the switch 140.

The news information provided to the terminal 150, 152 may be news information which is selected in response to a request from the terminal 150, 152. In this case, the steps of receiving a request for selective news provision from the terminal 150, 152, and selecting news information in response to the request, may be further performed.

In addition, when the amount of news information to be provided is set in advance, the steps of determining whether the amount of the information to be provided exceeds a predetermined reference value, and of deleting an excessive amount of news information, may be further performed.

According to the present invention, it is possible to standardize objects for news information extraction, and to enhance information providing speed by providing real time news information using an RSS.

While the present invention has been described with reference to exemplary embodiments thereof, it will be understood by those skilled in the art that various changes in form and detail may be made therein without departing from the scope of the present invention as defined by the following claims.

What is claimed is:

1. A system for providing real time news, comprising:
a news providing server for collecting and parsing RDF Site Summary (RSS) data, for extracting news information included in an RSS document, and for providing the extracted news information; and
at least one terminal for receiving the news information, and for displaying the received news information.

2. The system of claim 1, further comprising a switch for receiving the news information provided by the news providing server, and for transmitting the information to said at least one terminal.

3. The system of claim 2, wherein the switch converts the received news information so that it is suitable for display on said at least one terminal, and transmits the converted information to said at least one terminal.

4. The system of claim 1, wherein the news providing server comprises:
an RSS collector for collecting the RSS document; and
an RSS parser for extracting the news information to be provided from the collected RSS document.

5. The system of claim 4, wherein the RSS parser calculates a size of the extracted news information, provides an amount of news information corresponding to a predetermined reference value when it is determined that the news information exceeds the reference value, and deletes a remaining news information.

6. The system of claim 5, wherein the RSS parser determines when the amount of news information corresponding to the predetermined reference value includes any incomplete letter information before deleting the news information, and adjusts an amount of the news information to be deleted so that the incomplete letter information becomes complete letter information when it is determined that the news information corresponding to the reference value includes incomplete letter information.

7. The system of claim 6, further comprising a storage unit for storing the extracted news information.

8. The system of claim 4, wherein the RSS collector collects the RSS document by means of Hyper Text Transfer Protocol (HTTP).

9. The system of claim 4, wherein the RSS document is an eXtensible Markup Language (XML) document.

10. The system of claim 9, wherein the news information comprises at least title and content information included in the XML document; and
wherein the RSS parser extracts the news information included in the XML document by parsing the XML document.

11. The system of claim 1, wherein the terminal is at least one of a wired terminal, a wireless terminal, and a wired and wireless terminal including a display unit.

12. The system of claim 11, wherein the terminal is an offiserv terminal including a Liquid Crystal Display (LCD) with at least two lines as a display unit.

13. The system of claim 1, further comprising a keyphone news output server for receiving the extracted news information from the news providing server, for providing the extracted news information to the terminal, for selecting news information from the received news information in response to a request for selective news information provision, and for providing the selected news information to the terminal.

14. A method for providing real time news, comprising the steps of:
extracting news information included in an RDF Site Summary (RSS) document by collecting and parsing the RSS document; and
providing at least one terminal with the extracted news information.

15. The method of claim 14, further comprising the step of converting the extracted news information so that it is suitable for display on said at least one terminal.

16. The method of claim 14, further comprising the step of selecting, by each said at least one terminal, desired news information.

17. The method of claim 14, further comprising the steps of:
calculating a size of the extracted news information;
providing news information having a volume corresponding to a predetermined reference value when it is determined that the size exceeds the reference value; and
deleting remaining news information.

18. The method of claim 14, further comprising the step of storing the extracted information.
